(19) United States
(12) Patent Application Publication
(10) Pub. No.: US 2021/0080629 A1
(43) Pub. Date: Mar. 18, 2021

(54) LIGHT SOURCE MODULE

(71) Applicant: Young Optics Inc., Hsinchu (TW)

(72) Inventor: Wei-Hung Tsai, Hsinchu (TW)

(73) Assignee: Young Optics Inc., Hsinchu (TW)

(21) Appl. No.: 17/017,635

(22) Filed: Sep. 10, 2020

(30) Foreign Application Priority Data
Sep. 12, 2019 (TW) 108133124

(51) Int. Cl. G02B 5/18; G03B 21/20

(52) U.S. Cl. CPC G02B 5/1819; G03B 21/206

(57) ABSTRACT

A light source module including first, second and third color light sources, and first, second, third and fourth fixed gratings is provided. Colors of the first, second and third color light sources are substantially different, and light exit directions of the first, second and third color light sources are a first direction. The first fixed grating is disposed downstream the first color light source. The second fixed grating is disposed downstream the second color light source. The third fixed grating is disposed downstream the third color light source. The fourth fixed grating is disposed downstream the first, second and third fixed gratings. A first optical path between the first fixed grating and the first color light source, a second optical path between the second fixed grating and the second color light source, and a third optical path between the third fixed grating and the third color light source are independent.

### CROSS-REFERENCE TO RELATED APPLICATION

This application claims the priority benefit of Taiwan application no. 108133124, filed on Sep. 12, 2019. The entirety of the above-mentioned patent application is hereby incorporated by reference herein and made a part of this specification.

### TECHNICAL FIELD

The invention relates to a light source module, and more particularly, to a light source module used in a projector.

### BACKGROUND

A conventional projector with diode as light source includes a light source module, a light valve and a projection lens. The light source module usually includes optical elements such as multiple light-emitting diodes of different colors and multiple dichroic mirrors. Light rays of different colors are combined by two parallel dichroic mirrors to form an illumination beam, which then enters the light valve after being reflected by a total reflection surface of a total reflection prism (TIR PRISM). The light valve converts the illumination beam into an image beam, which is then output through the projection lens. However, the traditional light source module with a dichroic mirror structure is large in size, which is disadvantageous to the miniaturization of the projector.

### SUMMARY

One aspect of the invention is to provide a light source module, which greatly reduces a device thickness by using diffractive optical elements.

An embodiment of the invention provides a light source module, which includes a first color light source, a second color light source, a third color light source, a first fixed grating, a second fixed grating, a third fixed grating and a fourth fixed grating. Colors of the first color light source, the second color light source and the third color light source are substantially different, and light exit directions of the first color light source, the second color light source and the third color light source are all a first direction of the same. The first fixed grating is disposed downstream the first color light source. The second fixed grating is disposed downstream the second color light source. The third fixed grating is disposed downstream the third color light source. The fourth fixed grating is disposed downstream the first fixed grating, the second fixed grating and third fixed grating. A first optical path between the first fixed grating and the first color light source, a second optical path between the second fixed grating and the second color light source, and a third optical path between the third fixed grating and the third color light source are independent of each other.

Another embodiment of the invention provides a light source module, which includes a first waveguide, a second waveguide and a third waveguide sequentially arranged along a first direction. The first waveguide includes a first fixed grating. The second waveguide includes a second fixed grating, and the second fixed grating is disposed downstream the first fixed grating. The third waveguide includes a third fixed grating, and the third fixed grating is disposed downstream the first fixed grating and the second fixed grating. A light exit direction of the first color light source forms a first included angle with a second direction on a light incident surface of the first waveguide, and the first included angle is less than 70 degrees. A light exit direction of the second color light source forms a second included angle with the second direction on a light incident surface of the second waveguide, and the second included angle is less than 70 degrees. A light exit direction of the third color light source forms a third included angle with the second direction on a light incident surface of the third waveguide, and the third included angle is less than 70 degrees. Here, colors of the first color light source, the second color light source and the third color light source are different, and the first direction and the second direction are perpendicular to each other.

Based on the above, in the light source module of the invention, light beams provided by the light sources can be diffracted by the configuration of the fixed gratings to change a transmission direction and combine light. In this way, use of collimating optical elements can be reduced, and the device thickness can be greatly reduced.

To make the aforementioned more comprehensible, several embodiments accompanied with drawings are described in detail as follows.

### BRIEF DESCRIPTION OF THE DRAWINGS

FIG. 1A is a schematic diagram of a projector in a first embodiment of the invention.

FIG. 1B is a schematic diagram of a light source module in the first embodiment of the invention.

FIG. 1C is a schematic diagram of a structure of a fixed grating in an embodiment of the invention.

FIG. 2 is a partially enlarged view of the light source module of FIG. 1B.

FIG. 3 is a schematic diagram of a light source module in a second embodiment of the invention.

FIG. 4 is a schematic diagram of a light source module in a third embodiment of the invention.

FIG. 5 is a schematic diagram of a light source module in a fourth embodiment of the invention.

FIG. 6 is a schematic diagram of a light source module in a fifth embodiment of the invention.

### DETAILED DESCRIPTION

A waveguide is also called a wave guide. A fixed grating is a grating with a fixed refractive distribution and without external electrodes and electric fields that can change the refractive index distribution. In comparison, a switchable grating, such as a switchable Bragg gratings (SBG), is a diffraction device formed by recording a phase grating or a hologram in a polymer dispersed liquid crystal (PDLC) mixture. When an electric field is applied to the hologram through a transparent electrode, a natural orientation of the liquid crystal therein changes, thereby changing the refractive index distribution of the grating. The refractive index of the grating in the waveguide of the invention is fixed.

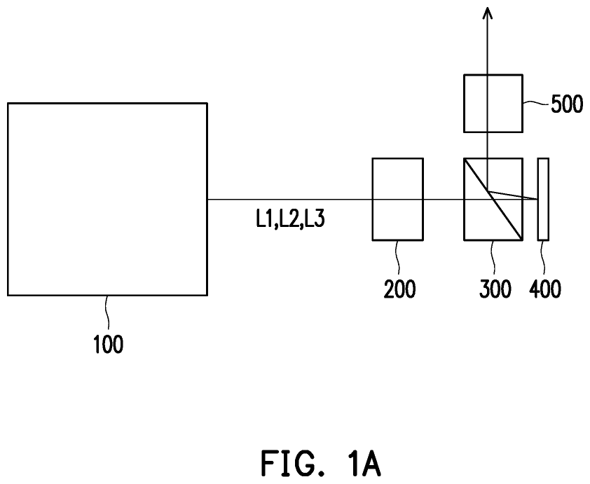

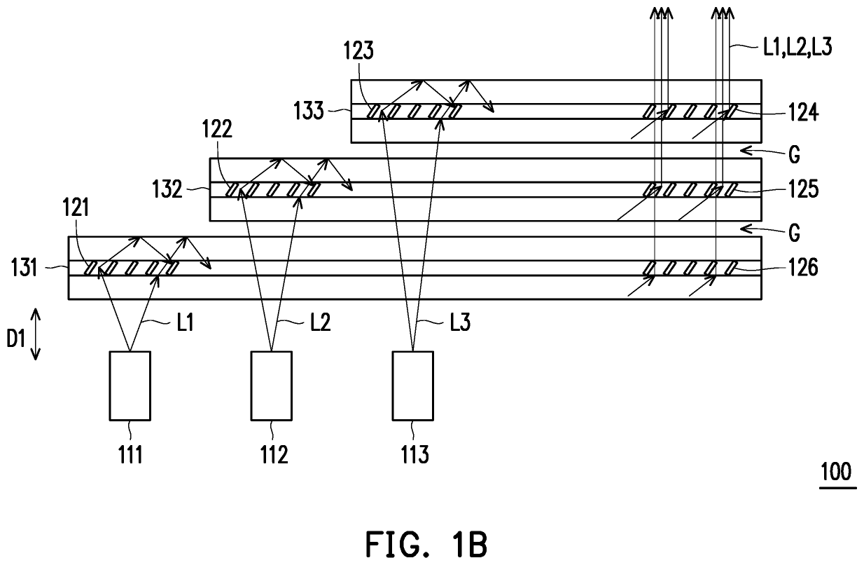

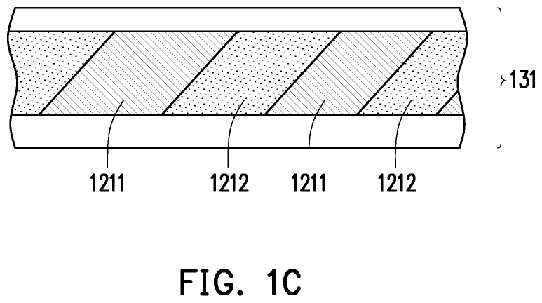

FIG. 1A is a schematic diagram of a projector in a first embodiment of the invention. In view of the drawing, a projector 1 includes a light source module 100, a light uniformizing element 200, a total reflection prism 300, a light valve 400 and a projection lens 500.

The uniformizing element 200 may be a flyeye lens, an integration rod and other known optical elements that can uniformize the light beam. In this example, the uniformizing element 200 is the flyeye lens.

The prism 300 may be a total reflection prism (TIR prism) or a reverse total reflection prism (TIR PRISM). In this example, the prism 300 is a total reflection prism composed of two triangular columnar prisms, but may be replaced by one prism in actual application.

The light valve 400 is an element that can convert an illumination light into an image light. The light valve can be a digital micro-mirror device (DMD), a liquid crystal (LCD) chip, a liquid crystal on silicon chip or other known elements that can convert the illumination light into the image light. In this example, the light valve 400 is the liquid crystal on silicon chip.

FIG. 1B is a schematic diagram of a light source module in the first embodiment of the invention. The following description refers to FIG. 1A and FIG. 1B. This embodiment provides a light source module 100 configured to provide an illumination light (light beams L1, L2 and L3) to the light valve 400 via a light uniformizing element 300.

In this example, the light source module 100 includes three light sources (light sources 111, 112 and 113) that can emit light of different colors, and six fixed gratings 121, 122, 123, 124, 125 and 126 for diffracting light rays. The fixed gratings 121, 122, 123, 124, 125 and 126 are respectively arranged in three waveguides (waveguides 131, 132 and 133). In this example, the waveguides 131, 132 and 133 are not arranged on optical paths of the light valve 400 and the projection lens 500. Further, referring to FIG. 1B, in this example, light rays output by the light sources 111, 112 and 113 are directly incident on the waveguide 131 without passing through other optical elements; and optical elements such as lenses, prisms, apertures, light uniformizing elements, and collimating elements may be optionally included or not included between the waveguide 131 and the light sources 111, 112 and 113 (the same also applies to the other embodiments of the invention).

The light rays and structural shapes drawn in the drawings of this embodiment are merely illustrative, and do not represent the actual light path and structural appearance.

The light source 111, the light source 112 and the light source 113 of the invention include a laser diode light emitting module of a laser diode light emitting chip (LD), or any other light sources that can output a collimating light ray, such as a light-emitting diode module including a light-emitting diode chip (LED), a collimating optical element, a polarized light adjustment unit (e.g., ½ wave plate, ¼ wave plate), a polarization beam splitter (PBS) or a combination thereof. In this example, each of the light sources 111, 112 and 113 is the laser diode light emitting module, and the light source 111, the light source 112 and the light source 113 can be used to output a monochromatic light ray. In this example, the light source 111 can output red light; the light source 112 can output green light; and the light source 113 can output blue light. That is to say, colors of the light rays output from the light sources 111, 112 and 113 are substantially different.

In this example, the first waveguide 131 includes two transparent plates made of glass or plastic, and an interlayer of polymer material is filled between the two plates. The fixed gratings are formed in specific areas in the interlayer.

Referring to FIG. 1C, FIG. 1C is a schematic diagram of a structure of a fixed grating in an embodiment of the invention. The structures of the fixed gratings 121, 122, 123, 124, 125 and 126 are similar and will not be repeated one by one. In view of the drawing, the fixed grating 121 is formed by a plurality of first material layers 1211 and second material layers 1212 arranged in staggered arrangement. The first material layer 1211 includes a polymeric material, and the second material layer 1212 is a mixture of polymer material and liquid crystal material. A refractive index difference between the first material layer 1211 and the second material layer 1212 can produce a refraction effect on light of a specific wavelength. In this embodiment, the fixed gratings 121, 122, 123, 124, 125 and 126 are transmission gratings. In addition to being formed between the transparent plates made of glass or plastic, the fixed gratings 121, 122, 123, 124, 125 and 126 may also be formed on a surface of one transparent plate. Further, in addition to the liquid crystal and polymer material, the fixed gratings 121, 122, 123, 124 125 and 126 may also be made of other materials, which are not particularly limited by the invention.

In this embodiment, when a thickness of the first waveguide 131 along a first direction D1 is greater than 0.1 mm and less than or equal to 5, 3 and 1.5 mm, ratios of volume to strength are “best”, “better” and “good”, respectively. In this example, the thickness is approximately 1 mm, but the invention is not limited thereto. In this example, the fixed grating 121 is sandwiched and fixed by the upper and lower transparent plates (the glass plates). Upper and lower surfaces of the transparent plate can form a total reflection interface. With the total reflection interface, the light beam can be totally reflected between the upper and lower transparent plates to be transmitted to a specific position, and thus use of the collimating optical elements can be reduced. The design of the second waveguide 132 and the third waveguide 133 is similar to that of the first waveguide 131 and will not be repeated. Compared with the design of two transparent plates, in another example, one of the plates can be omitted and the interlayer can also be exposed.

In this embodiment, the fixed grating 121 and the fixed grating 126 can deflect red light; the fixed grating 122 can deflect green light; the fixed grating 125 can deflect green light, and allow red light to pass through; the fixed grating 123 can deflect blue light; the fixed grating 124 can deflect blue light, and allow red light and green light to pass through; that is, the fixed gratings 121, 122, 123, 124, 125 and 126 respectively have optical effects on the light beams of different wavelengths.

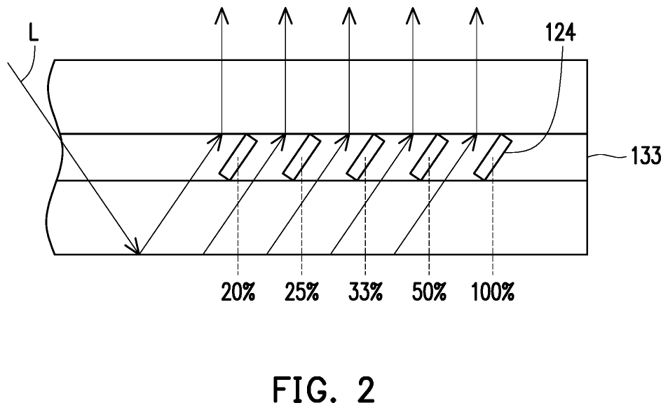

In different embodiments, the specific light beams that the fixed gratings 121, 122, 123, 124, 125 and 126 can act on may be changed by designing a concentration or a geometric structure of liquid crystal molecule. For example, the refractive index difference between liquid crystal molecule and polymer material may be changed by adjusting a concentration of liquid crystal molecule relative to polymer material in each region of the fixed grating. Accordingly, a diffraction efficiency of each area of the fixed grating may be adjusted, as shown in FIG. 2. On the other hand, the diffraction efficiency may also be changed by adjusting an inclination angle of an interface between the first material layer and the second material layer in the fixed grating, and an arrangement density of the first material layer and the second material layer (length and density of the period).

For example, the fixed grating 126 can adjust a traveling direction of red light and make red light pass the fixed grating 126 to be output through its light exit surface from the first waveguide. In other embodiments, the fixed grating 121 to the fixed grating 126 may use a reflection grating so that the light beam of the corresponding wavelength can be reflected out of the waveguide. Meanwhile, the reflection grating can selectively allow other light beams with different wavelengths to pass.

In this embodiment, the first waveguide 131, the waveguide 132, and the waveguide 133 are stacked in sequence along the first direction D1 and have a gap G of at least a micrometer level from each other. There may be air in the gap G. The fixed grating 121 is arranged in the first direction D1 of the light source 111 and disposed in the first waveguide 131; the fixed grating 122 is arranged in the first direction D1 of the light source 112 and disposed in the waveguide 132; the fixed grating 123 is arranged in the first direction D1 of the light source 113 and disposed in the waveguide 133. The fixed grating 121, the fixed grating 122 and the fixed grating 123 are respectively offset in the first direction D1. In other words, optical paths between the light source 111, the light source 112, the light source 113 and the fixed grating 121, the fixed grating 122 and the fixed grating 123 are independent and not staggered. The light source 111, the light source 112 and the light source 113 are respectively offset in the first direction D1 and provide the first light beam L1, the second light beam L2 and the third light beam L3 of different colors to the fixed grating 121, the fixed grating 122 and the fixed grating 123, respectively. The first light beam L1, the second light beam L2 and the third light beam L3 are diffracted by the fixed grating 121, the fixed grating 122 and the fixed grating 123, and transmitted inside the waveguide 131, the waveguide 132 and the waveguide 133, respectively. While being transmitted inside the waveguides, the first light beam L1, the second light beam L2 and the third light beam L3 are respectively totally reflected by surfaces due to the refractive index difference between the first waveguide 131, the waveguide 132 and the waveguide 133 and air in the gap G or air outside.

The fixed grating 124 is disposed downstream (i.e., downstream the optical paths of) the fixed grating 121, the fixed grating 122 and the fixed grating 123; the fixed grating 125 is disposed downstream the fixed grating 122; and the fixed grating 126 is disposed downstream the fixed grating 121. Here, the fixed grating 124, the fixed grating 125 and the fixed grating 126 overlap each other in the first direction D1. In other words, the first light beam L1 transmitted in the first waveguide 131 through the diffraction of the fixed grating 121 will be diffracted by the fixed grating 126 to exit the fixed grating 124. The second light beam L2 transmitted in the first waveguide 132 through the diffraction of the fixed grating 122 will be diffracted by the fixed grating 125 to exit the fixed grating 124 and combined with the first light beam L1. The third light beam L3 transmitted in the first waveguide 133 through the diffraction of the fixed grating 123 will be diffracted by the fixed grating 124 to exit the waveguide 133 and combined with the first light beam L1 and the second light beam L2. Therefore, with the design of the fixed gratings and the waveguides, the light source module 100 of this embodiment can combine the first light beam L1, the second light beam L2 and the third light beam L3, and the first waveguide 131, the waveguide 132 and the waveguide 133 occupy only approximately 3 mm in thickness. In this way, use of the collimating optical elements can be reduced, and the device thickness can be greatly reduced.

FIG. 2 is a partially enlarged view of the light source module of FIG. 1B. Referring to FIG. 1B and FIG. 2 together, in this embodiment, the fixed grating can produce different degrees of diffraction for a light beam L according to a material arrangement density, a material concentration or a geometric structure design. For example, in the waveguide 133, the degrees of diffraction in different sections of the fixed grating 124 can be configured from an end adjacent to a light incident side to an end far away from the light incident side as 20%, 25%, 33%, 50% and 100%, respectively. Accordingly, the light beam L can generate the same luminous intensity of 20% of the incident light intensity in these different sections. In this way, the design of the fixed grating in different sections can further improve a light uniformity.

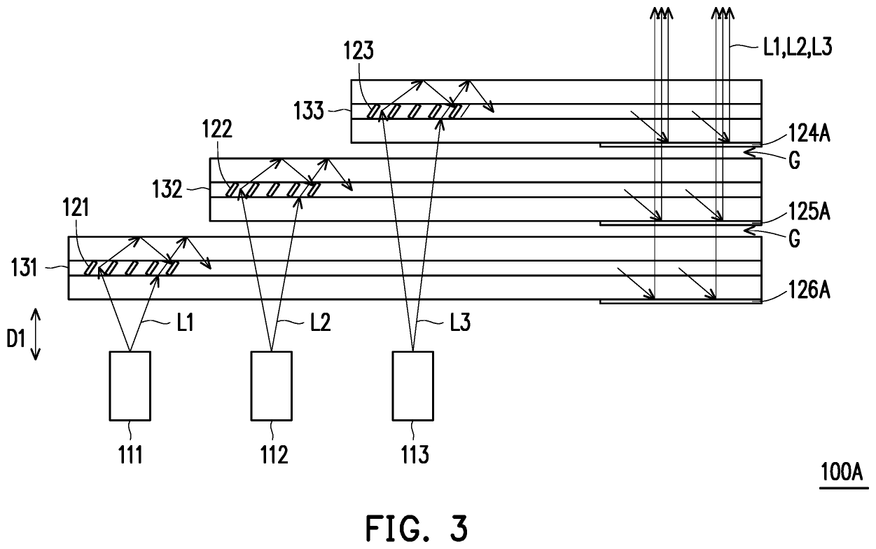

FIG. 3 is a schematic diagram of a light source module in a second embodiment of the invention. Referring to FIG. 3, a light source module 100A of this embodiment is similar to the light source module 100 depicted in FIG. 1B. The difference between the two is that in this embodiment, at least one of the fixed grating 121 to a fixed grating 126A in the light source module 100A is the reflection grating. For example, in this embodiment, the fixed grating 124A, the fixed grating 125A and the fixed grating 126A are the reflection gratings. However, in different embodiments, the invention is not limited in this regard.

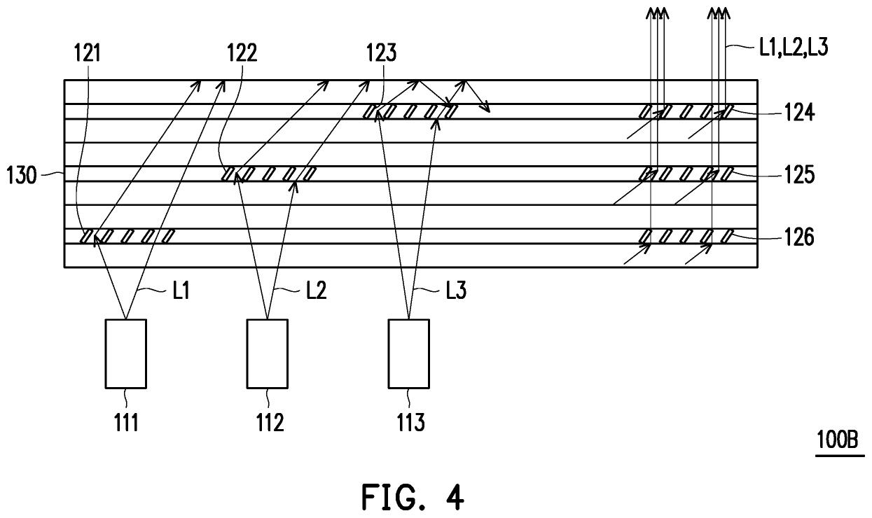

FIG. 4 is a schematic diagram of a light source module in a third embodiment of the invention. Referring to FIG. 4, a light source module 100B of this embodiment is similar to the light source module 100 depicted in FIG. 1B. The difference between the two is that, in this embodiment, a waveguide 130 includes the fixed grating 121 to the fixed grating 126. In detail, the fixed grating 121 to the fixed grating 126 have the same relative positions as the relative positions depicted in FIG. 1B, but are disposed in the same waveguide 130. That is, the first light beam L1, the second light beam L2 and the third light beam L3 are totally reflected by surfaces and air outside in the waveguide 130. Regarding a relative arrangement of the fixed grating 121 to the fixed grating 126 in the first direction D1, a plurality of glass plates can be provided to separate them, as shown in FIG. 4. For example, this embodiment uses six glass plates to sandwich and fix three grating structures, but the invention is not limited thereto. In another embodiment, the waveguide 130 can respectively replace two glass plates between the fixed grating 121 and the fixed grating 122 and between the fixed grating 122 and the fixed grating 123 by one glass plate; that is, only four glass plates are included. By reducing the number of glass plates, the thickness of the waveguide 130 can be reduced to only approximately 2 mm.

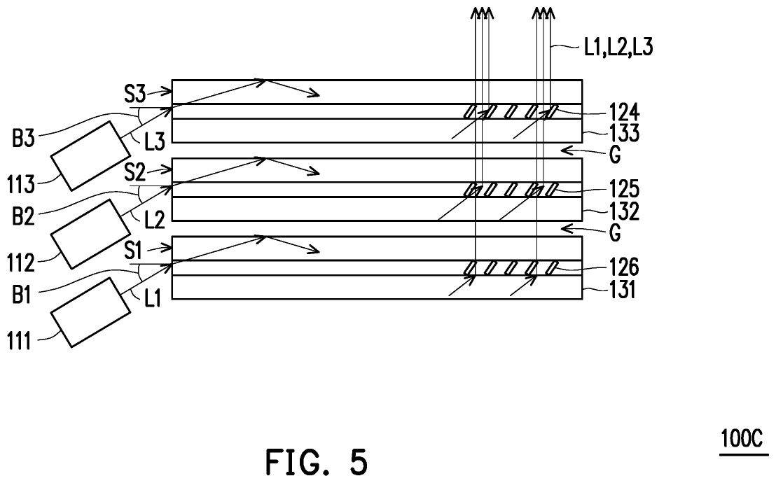

FIG. 5 is a schematic diagram of a light source module in a fourth embodiment of the invention. Referring to FIG. 5, a light source module 100C of this embodiment is similar to the light source module 100 illustrated in FIG. 1B. The difference between the two is that in this embodiment, each of the light sources is incident sideways so that the number of fixed gratings can be reduced.

In order to allow an incident light beam to be totally reflected in each of the waveguides, an incident angle of each of the waveguides 131, 132 and 133 in the embodiment shown in FIG. 5 is limited. A light exit direction of the light source 111 (a first color light source) forms an included angle less than 70 degrees with a second direction D2 on an incident surface S1 of the waveguide 131. The second direction D2 and the first direction D1 are perpendicular to each other. A light exit direction of the light source 112 (a second color light source) forms an included angle less than 70 degrees with the second direction D2 on an incident surface S2 of the waveguide 132. A light exit direction of the light source 113 (a third color light source) forms an included angle less than 70 degrees with the second direction D2 on an incident surface S3 of the waveguide 133.

In this example, the refractive index of the glass plate on the waveguide 131 is approximately 1.7. Accordingly, when an included angle B1 is approximately 65 degrees or less, a total reflection efficiency can be higher. Considering plate material difference and the refractive index difference of the waveguides, the relevant included angles should also be adjusted. However, in general, the first included angle B1, a second included angle B2, and a third included angle B3 are recommended to be less than (including) 70 degrees, and the effects of total reflection are “good”, “better”, and “best” when the included angle is less than 60 degrees, 45 degrees and 30 degrees, respectively.

The first light beam L1, the second light beam L2 and the third light beam L3 respectively emitted by the light source 111, the light source 112 and the light source 113 are incident from lateral sides of the first waveguide 131, the waveguide 132 and the waveguide 133, respectively. Therefore, the first light beam L1, the second light beam L2 and the third light beam L3 can be respectively transmitted in the first waveguide 131, the waveguide 132 and the waveguide 133 to achieve a total reflection condition. In addition, the fixed grating 131, the fixed grating 132 and the fixed grating 133 are changed to allow the first light beam L1, the second light beam L2 and the third light beam L3 to exit the waveguides to be combined and overlap with each other in the first direction D1 of the fixed grating 131, the fixed grating 132 and the fixed grating 133. In this way, the light source module 100C of this embodiment can reduce the number of fixed gratings and greatly reduce the device thickness.

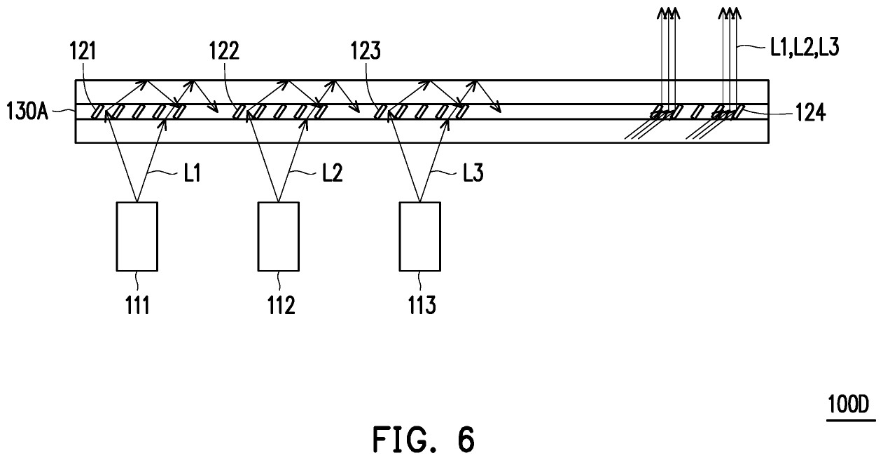

FIG. 6 is a schematic diagram of a light source module in a fifth embodiment of the invention. Referring to FIG. 6, Referring to FIG. 6, a light source module 100D of the present embodiment is similar to the light source module 100 shown by FIG. 1B. The difference between the two is that in this embodiment, only one waveguide 130A is configured, and the waveguide 130A includes the fixed gratings 121, 122, 123 and 124. In other words, the first light beam L1, the second light beam L2, and the third light beam L3 respectively emitted by the light source 111, the light source 112 and the light source 113 are simultaneously transmitted through the total reflection in the waveguide 130A to the fixed grating 124, and exit the waveguide 130A through the fixed grating 124 to be combined together. In this embodiment, the thickness of the waveguide 130A is only approximately 1 mm. In this way, use of the collimating optical elements can be reduced, and the device thickness can be greatly reduced. The fixed grating 124 can deflect the light rays of the corresponding colors of the light sources 111, 112 and 113 to be output from the waveguide 130A.

In summary, in the light source module of the invention, the light beams provided by the light sources can be diffracted by the configuration of the fixed grating to change the transmission direction and combine light. In this way, use of the collimating optical elements can be reduced, and the device thickness can be greatly reduced.

Although the present invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

1. A light source module, comprising:
a first color light source;
a second color light source;
a third color light source, wherein colors of the first color light source, the second color light source and the third color light source are substantially different, and light exit directions of the first color light source, the second color light source and the third color light source are all a first direction of the same;
a first fixed grating, disposed downstream the first color light source;
a second fixed grating, disposed downstream the second color light source;
a third fixed grating, disposed downstream the third color light source; and
a fourth fixed grating, disposed downstream the first fixed grating, the second fixed grating and the third fixed grating;
wherein
a first optical path between the first fixed grating and the first color light source, a second optical path between the second fixed grating and the second color light source, and a third optical path between the third fixed grating and the third color light source are independent of each other.

2. The light source module of claim 1, further comprising:
a fifth fixed grating, disposed downstream the second color light source; and
a sixth fixed grating, disposed downstream the first color light source;
wherein
the fifth fixed grating is disposed downstream the sixth fixed grating;
the fourth fixed grating is disposed downstream the fifth fixed grating and the sixth fixed grating.

3. The light source module of claim 2, wherein at least one of the first fixed grating, the second fixed grating, the third fixed grating, the fourth fixed grating, the fifth fixed grating and the sixth fixed grating is a reflection grating.

4. The light source module of claim 2, further comprising:
a first waveguide, comprising the first fixed grating and the sixth fixed grating;
a second waveguide, comprising the second fixed grating and the fifth fixed grating; and
a third waveguide, comprising the third fixed grating and the fourth fixed grating.

5. The light source module of claim 4, wherein a gap is provided between the first waveguide, the second waveguide and the third waveguide.

6. The light source module according to claim 1, wherein the first fixed grating, the second fixed grating, the third fixed grating and the fourth fixed grating are disposed in one waveguide.

7. The light source module according to claim 6, wherein the first fixed grating, the second fixed grating, the third fixed grating, the fourth fixed grating, the fifth fixed grating and the sixth fixed grating are disposed in one waveguide.

8. A light source module, comprising:
a first waveguide, a second waveguide and a third waveguide sequentially arranged along a first direction;
the first waveguide comprising a first fixed grating;
the second waveguide comprising a second fixed grating, the second fixed grating being disposed downstream the first fixed grating;
the third waveguide comprising a third fixed grating, the third fixed grating being disposed downstream the first fixed grating and the second fixed grating;
a first color light source, a light exit direction of the first color light source forming a first included angle with a second direction on a light incident surface of the first waveguide, the first included angle being less than 70 degrees;
a second color light source, a light exit direction of the second color light source forming a second included angle with the second direction on a light incident surface of the second waveguide, the second included angle being less than 70 degrees; and
a third color light source, a light exit direction of the third color light source forming a third included angle with the second direction on a light incident surface of the third waveguide, the third included angle being less than 70 degrees;
wherein colors of the first color light source, the second color light source and the third color light source are different, and the first direction and the second direction are perpendicular to each other.

9. The light source module of claim 8, wherein a gap is provided between the first waveguide, the second waveguide and the third waveguide.

10. The light source module of claim 8, wherein at least one of the first fixed grating, the second fixed grating and the third fixed grating is a reflection grating.
